(19) United States
(12) Patent Application Publication
(10) Pub. No.: US 2021/0172601 A1
(43) Pub. Date: Jun. 10, 2021

(54) METHOD FOR OPERATING A COMBUSTION ARRANGEMENT AND COMBUSTION ARRANGEMENT

(71) Applicant: Frank Ostermann, Eschweller (DE)

(72) Inventor: Wolfgang Kirschbaum, Heek (DE)

(21) Appl. No.: 17/169,888

(22) Filed: Feb. 8, 2021

Related U.S. Application Data
(63) Continuation of application No. PCT/EP2019/072237, filed on Aug. 20, 2019.

(30) Foreign Application Priority Data
Aug. 20, 2018 (DE) DE102018120196.6

(51) Int. Cl. F23N 1/02

(52) U.S. Cl. CPC F23N 1/027

(57) ABSTRACT

A method for operating a combustion arrangement, the combustion arrangement including at least one combustor chamber arranged in a double-walled housing, at least one inlet configured to supply a fuel to the at least one combustion chamber, at least one outlet for letting exhaust air from the at least one combustion chamber, and at least one air channel configured to feed supply air into the housing, wherein the housing includes an inner wall and an outer wall which jointly define an intermediate space between each other, wherein an air inlet opening that cooperates with the at least one air channel is arranged in an upper end section of the outer wall so that the supply air is feedable through the at least one air channel into the intermediate space.

### RELATED APPLICATIONS

This application is a continuation of International application PCT/EP2019/072237 filed on Aug. 20, 2019 claiming priority from German patent application DE 10 2018 120 196.6 filed on Aug. 20, 2018, both of which are incorporated in their entirety by this reference.

### FIELD OF THE INVENTION

The instant invention relates to a method for operating a combustion arrangement according to the preamble of patent claim 1. The invention furthermore relates to a combustion arrangement according to the preamble of claim 8.

### BACKGROUND OF THE INVENTION

A generic combustion arrangement includes a double wall housing that includes an interior inner wall and an outer wall that envelops the inner wall. The housing can be configured in particular with a circular cross section. A configuration with a polygonal cross section, in particular a rectangular or square cross section is also conceivable. An intermediate space is arranged between the inner wall and the outer wall. A combustion chamber is arranged within the interior space in which a fossil or renewable fuel can be burned. In particular it is feasible to burn pellets that are made from renewable raw materials. In order to sustain combustion, it is necessary to feed supply air to the combustion chamber. Therefore the combustion arrangement includes at least one air channel that facilitates conducting supply air into the housing. Furthermore, the combustion arrangement includes at least one exhaust that is configured to exhaust exhaust gas from the combustion chamber. This can be in particular exhaust gas that is produced by combusting a respective fuel. The combustion arrangement furthermore includes a respective supply conduit to feed fuel into the combustion chamber.

The air channel that facilitates conducting supply air into the housing is connected to the housing in an upper end section of the outer wall of the housing. Accordingly, the combustion arrangement includes an air inlet opening in an upper end section of the outer wall wherein the air inlet opening cooperates with the air channel. This way supply air is conductible into the intermediate space between the inner wall and the outer wall. The intermediate space and the combustion chamber are furthermore flow connected with each other so that supply air introduced into the intermediate space is transferable into the combustion chamber. This is performed in particular in a lower end section of the housing, wherein the supply air is run from the air inlet opening arranged in the upper end section towards the lower end section of the housing before the supply air is introduced into the combustion chamber at least indirectly.

Combustion arrangements of the generic type described supra are already known in the art, e.g.; from EP 2 458 275 A1. This document describes an oven for combusting renewable raw materials like e.g.; wood or wood chips. The oven includes a double wall housing that envelops a combustion chamber. The oven includes a blower at a top side of an outer wall of the housing wherein supply air is feedable by the blower into an intermediate space that is arranged between the outer wall and an inner wall of the housing. The supply air is run in a helix shape about the combustion chamber within the intermediate space, this means about the inner wall and thus heated, wherein the inner wall is cooled simultaneously. The heated supply air is eventually conducted through pass through openings into the combustion chamber and thus becomes available for combustion.

Other combustion arrangements are known e.g.; from the documents US 2007/0272201 A1 and EP 2 236 940 A1.

Known combustion arrangements are typically not suitable to burn highly compressed solid fuels. These can be e.g.; compressed pellets that are made from waste material, in particular agricultural waste material. It is conceivable for example to dry agricultural manure and press it into pellets. Pellets of this type have significantly inferior combustion properties compared to wood. It has become evident that the known combustion arrangements do not operate satisfactory with a fuel of this type.

### BRIEF SUMMARY OF THE INVENTION

Thus, it is an object of the instant invention to provide a method and a combustion arrangement that also facilitate burning highly compressed solid fuels.

The object is achieved according to the invention by a method for operating a combustion arrangement, the combustion arrangement including at least one combustion chamber arranged in a double-walled housing, at least one inlet configured to supply a fuel to the at least one combustion chamber, at least one outlet for letting exhaust air from the at least one combustion chamber, and at least one air channel configured to feed supply air into the housing, wherein the housing includes an inner wall and an outer wall which jointly define an intermediate space between each other, wherein an air inlet opening that cooperates with the at least one air channel is arranged in an upper end section of the outer wall so that the supply air is feedable through the at least one air channel into the intermediate space, wherein the intermediate space and the at least one combustion chamber that is enveloped by the inner wall are flow connected so that the supply air conducted into the intermediate space is transferable into the at least one combustion chamber, the method comprising the steps: introducing the supply air into the upper end section of the housing through the at least one air channel; guiding the supply air in the intermediate space towards a lower end section of the housing; introducing the supply air into the at least one combustion chamber; and initially running the supply air out of the housing through an air conduit that cooperates with an air outlet opening arranged in the outer wail; and thereafter running the supply air into the at least one combustion chamber at least indirectly.

The method according to the invention is characterized in that the supply air is first introduced into the intermediate space, then run out of the housing by an air conduit before being introduced into the combustion chamber at least indirectly. Thus, the air conduit cooperates with an air exit opening arranged in the outer wall wherein the supply air is run through the air outlet opening from the intermediate space and thus out of the housing. In particular the supply air can be transferred by the air conduit into a separate portion of the intermediate space that is separated from the portion of the intermediate space that is fed with the supply air by the air channel. The intermediate space can be divided e.g, by an intermediate floor into two portions that are separated from each other. The air conduit can feed the supply aft from the first portion to the second separate portion of the intermediate space. Starting from this separate portion the supply air is conducted to the combustion chamber so that the supply air is conducted to the combustion chamber through the air conduit indirectly. For indirect feeding the air conduit is connected to the inner wall indirectly wherein the air conduit can penetrate in particular the intermediate space. In this embodiment the supply air can flow indirectly through a transfer opening from the air conduit into the combustion chamber.

The method according to the invention has many advantages. In particular, guiding the supply air through the air conduit before transferring it into the combustion chamber generates the ability to interrupt a flow in the intermediate space that runs in the intermediate space in particular in a helix shape about the inner wall and then feed supply air in a controlled manner with different flow characteristics into the combustion chamber. Feeding the preheated supply air to the combustion chamber can thus be set in a precise manner which allows controlling the combustion in the combustion chamber. In particular, it is possible to feed the supply air that is fed to the combustion chamber in a circular pattern according to a turbulence chamber principle initially about the burn table on which the respective fuel is burned and then in a radial direction towards the flame. This type of air guidance has proven particularly positive for burning highly compressed solid fuels.

As recited supra it can be particularly advantageous when the intermediate space is divided by an intermediate floor into an upper portion and a lower portion. Advantageously the intermediate floor is horizontally oriented and arranged in the lower end portion of the housing. The air conduit is thus arranged at the housing so that the supply air that is introduced in the upper end section and thus in the top portion of the housing into the intermediate space is conducted exclusively by the air conduit from the upper portion into the lower portion of the intermediate space. The interruption of the intermediate space by the intermediate floor has the consequence that a flow of the feed air that exists in the upper portion and that runs in particular in a helix shape about the inner wall is not transferrable to a flow in the lower portion of the intermediate space. Instead, the flow characteristics of the supply air are interrupted in the upper portion of the intermediate space by introducing the supply air into the air conduit and the associated conduction of the supply air out of the housing. Thereafter, new flow characteristics are imparted upon the supply air while being fed to the lower portion of the intermediate space.

Advantageously, the supply air is fed to the combustion chamber after being fed to the lower portion of the intermediate space through at least one transfer opening. Advantageously, the lower portion of the intermediate space and the combustion chamber are flow connected with each other by a plurality of transfer openings. Conceivably the inner wall includes at least four transfer openings that are arranged evenly spaced in a horizontal plane, this means offset from each other respectively by 90 degrees in the inner wall. Transfer openings are advantageously configured with a small cross section, in particular in a form of horizontal slots so that the transfer openings function as throttles so that the overflow of the supply air from the lower portion of the intermediate space into the combustion chamber essentially occurs evenly through all transfer openings. Furthermore, the throttle effect leads to a local acceleration of the flow of the supply air. The higher flow velocity of the supply air causes a turbulent combustion in the combustion chamber which can then generate higher temperatures and a breakup of the highly compressed solid fuel.

Advantageously, the supply air is deflected by at least one air control element when transitioning into the combustion chamber. This deflection is advantageously performed so that the supply air is imparted with a tangential flow component. This has the effect that the supply air when entering the combustion chamber is not fed directly in a radial direction to the combustion table and thus to the fire but initially flows in a circular vortex about the combustion table which has proven particularly advantageous for the combustion reaction. The radial feeding of the supply air towards the combustion table or the fire arranged thereon is caused by the low pressure or suction in the portion of the combustion table that occurs due to the oxygen consumption of the combustion reaction.

As recited supra, it is particularly advantageous when the supply air is run in a spiral shape about the inner wall during flow from the air inlet opening arranged in the upper end section of the housing in a direction to the air outlet opening of the outer wall arranged in the lower end section of the housing. This air routing causes much stronger heating of the supply air along the inner wall compared to running the supply air only in a linear manner vertically along the inner wall in a downward direction. The spiral routing has the effect that an air guide path along which the supply air flows along the inner wall of the combustion arrangement is rather long. Accordingly, a dwelling time of the supply air at the inner wall is also rather long which heats the supply air by a particularly high amount. Put differently, a rather high amount of thermal energy can be transferred from the inner wall to the supply air. The high temperature of the supply air during introduction into the combustion chamber is particularly important when burning solid fuels with a high degree of compression.

The helical flow of the supply air about the inner wall can be forced in particular by air control elements. Thus, the supply air is advantageously deflected by at least one air control element within the intermediate space. It is particularly advantageous when the supply air is conducted to an air control element immediately after transitioning from the air channel through the air inlet opening into the intermediate space so that the helical flow is imparted upon the supply air by the air control element.

Alternatively, or in addition to deflecting the supply air by at least one air control element it can be advantageous to introduce the supply air with a tangential directional component into the intermediate space in a horizontal sectional plane of the combustion arrangement. Advantageously the air channel is arranged at a slant angle to the outer wall at least in a connection portion where the air channel is connected directly to the outer wall of the housing so that a main flow direction of the supply air in the air inlet opening encloses an angle between 60 degrees and 90 degrees, advantageously between 70 degrees and 90 degrees, further advantageously between 80 degrees and 90 degrees relative to the outer wall in a portion of the air inlet opening. This way the supply air is already fed to the intermediate space with a tangential flow component so that the spiral shaped flow can be set up.

The object of the intervention is also achieved by a combustion arrangement configured to burn pellets made from renewable material, the combustion arrangement comprising: at least one combustion chamber arranged in a double-walled housing; at least one inlet for supplying a fuel to the at least one combustion chamber;

at least one outlet for letting exhaust air out of the at least one combustion chamber; and at least one an air channel configured to feed supply air into the housing, wherein the housing includes an inner wall and an outer wall which jointly define an intermediate space between each other, wherein an air inlet opening that cooperates with the at least one air channel is arranged in an upper end section of the outer wall so that the supply air is feedable through the at least one air channel into the intermediate space, wherein the intermediate space and the at least one combustion chamber that is enveloped by the inner wail are flow connected so that the supply air conducted into the intermediate space is transferable into the at least one combustion chamber, wherein a first end of an air conduit cooperates with an air outlet opening that is arranged in the outer wall in a lower end section of the housing, wherein at least an outer section of the air conduit extends outside of the housing, and wherein the supply air is conductible from the air outlet opening into the combustion chamber at least indirectly.

The combustion arrangement according to the invention is characterized by an air conduit that cooperates with an air outlet opening at a first end of the air conduit wherein the air outlet opening is arranged in a lower end section of the housing. The air conduit extends from the air outlet opening out of the housing or in a direction away from the housing so that at least an outer section of the air conduit extends outside of the housing. Last not least the air conduit is configured so that the supply air is feedable by the air conduit to the combustion chamber at least indirectly. This indirect feeding can feed the supply air through the air conduit initially back into the intermediate space, in particular into a separate portion of the intermediate space before the supply air is fed into the combustion chamber through at least one transfer opening of the inner wall. In particular the air conduit can cooperate with a flow through cross-section that is arranged in the outer wall. Alternatively, indirect feeding of the supply air to the combustion chamber can include connecting the air conduit from the outlet opening directly to the inner wall so that the supply air is introducible into the combustion chamber through a transfer opening arranged at a second end of the air conduit that is arranged opposite to the air outlet opening. Advantageously, the air conduit is run in this embodiment in the radial direction through a pass through opening of the outer wall and through the intermediate space.

The method according to the invention can be performed by the combustion arrangement according to the invention in a particularly simple manner. This achieves the advantages recited supra. In particular an option is provided to impart flow characteristics upon the supply air after heating wherein the supply air flows into the intermediate space along the interior wall wherein the flow characteristics are advantageous for burning also highly compressed solid fuels.

In an advantageous embodiment of the combustion device according to the invention the combustion device includes an intermediate floor that divides the intermediate space into an upper portion and a lower portion. Advantageously the intermediate floor is arranged in a lower end section of the housing wherein the intermediate floor is advantageously arranged directly below the air outlet opening. The air conduit thus runs from the air outlet opening and thus the upper portion of the intermediate space into the lower portion of the intermediate space arranged thereunder. Flow characteristics that are imparted upon the supply air in the lower portion are thus adjustable completely independently from flow characteristics of the upper portion of the intermediate space. The air conduit is advantageously connected to a pass through opening that is arranged in the outer wall so that the air conduit is respectively connected to the outer wall with both ends. In particular the air conduit can be configured as a 180° arc that is vertically oriented, this means both its ends are arranged on top of each other.

Advantageously the inner wall includes at least one, advantageously a plurality of overflow openings that establish a flow connection between the intermediate space and the combustion chamber. Advantageously the transfer openings are arranged in a portion of the intermediate space which is structurally separated from the upper portion of the intermediate space, in particular by an intermediate floor. When a plurality of transfer openings is provided it is advantageous for the transfer openings to be spaced in uniform intervals along the interior wall.

Advantageously the outer wall includes a pass-through opening that cooperates with the air conduit. In particular the pass-through opening can be flow connected with a second end of the air conduit so that the air coming from the air outlet opening that is flow connected with the first end of the air conduit is feedable to the second end and thus to the pass-through opening through which the supply air is feedable to the intermediate space again. The pass-through opening can be arranged in particular in the portion of the intermediate space described supra. This way the supply air is only conductible by the air conduit from the upper portion of the intermediate space to the lower portion of the intermediate space. Flow characteristics of the supply air that prevail in the upper portion are thus disturbed by the flow of the supply air through the air conduit so that new flow characteristics can be imparted upon the supply air in the lower portion.

In an advantageous embodiment of the combustion arrangement according to the invention the air channel is connected to the outer wall of the housing so that a center axis of the air channel encloses an angle between 60° and 90°, advantageously between 70° and 90° and further advantageously between 80° and 90° with the outer wall in the portion of the air inlet opening. This way it is possible to impart a tangential flow direction to the supply air that is fed by the air channel to the intermediate space during feeding that is then easily transferable into spiral shaped flow characteristics within the intermediate space. This way it is possible in a particularly simple manner to conduct the supply air from the air entry opening in a spiral shape along the inner wall in a direction towards the lower end section of the housing and thus towards the air outlet opening. The associated advantages have already been described supra.

Independently from the orientation of the air channel relative to the housing it can be particularly advantageous when the combustion arrangement includes a plurality of air control elements that are arranged in the intermediate space. Advantageously one of the air control elements, advantageously all air control elements are arranged at the inner wall of the housing wherein the air control elements extend from the inner wall towards the outer wall and thus within the intermediate space. Using the air control elements, it is possible in a particularly simple manner to impart the intended helical flow characteristics upon the supply air within the intermediate space, wherein the helical flow characteristics lead to a particularly strong heating of the supply air at the inner wall of the housing. The air control elements can be formed in particular by guide plates. Guide plates of this type facilitate controlling the flow characteristics of the supply aft through suitable inclination and dimensions.

In another advantageous embodiment of the combustion arrangement the intermediate space is divided into a wide portion and a narrow portion. In the wide portion a horizontally measured width of the intermediate space exceeds a width of the intermediate space measured in the narrow portion. In a housing that is typically formed with a circular cross section a diameter of the outer wall is advantageously constant over a height of the housing, whereas a diameter of the inner wall differs over the height of the housing. In particular it can be advantageous when the diameter of the inner wall in a upper end section of the housing is smaller than in a lower end section of the housing. Advantageously the diameter of the inner wall leaps from a small diameter to a large diameter. The wide portion of the intermediate space is a portion where the inner wall has the small diameter whereas the narrow portion is a portion of the intermediate space where the inner wall has the large diameter.

The wide portion of the intermediate space corresponds advantageously with the air inlet opening of the air channel. This has the particular advantage that sufficient space is available in the wide portion to deflect the supply air conducted into the intermediate space by comparatively large air control elements so that the supply air subsequently has the desired, in particular helical flow characteristics. As soon as the supply air has the desired flow characteristics the larger space that the intermediate space encloses in its wide portion is no longer necessary to control the flow of the supply air in the desired manner. Instead, the large diameter of the inner wall provides a larger circumferential surface of the inner wall that is available as a heat exchanger surface for the supply air. Therefore, efficient heating of the supply air can be provided in a particularly simple manner in the narrow portion of the intermediate space. The air outlet opening through which the supply air is run out of the housing through the air conduit according to the invention is advantageously arranged in the narrow portion of the intermediate space.

Irrespective of the smaller available space flow control of the supply air is also possible in the narrow portion wherein in particular air control elements that extend in a circumferential direction of the inner wall or that are slightly inclined relative to the circumferential direction can be arranged at the inner wall. The flow control elements can help to maintain the desired spiral shaped flow of the supply air in the narrow portion and to control the helical flow of the supply air with a rather small pitch. The air control path along which the supply air flows through the intermediate space between the air entry opening and the air outlet opening is particularly long then which facilitates the intended heat transfer from the inner wall to the supply air.

### BRIEF DESCRIPTION OF THE DRAWINGS

The invention is now described based on embodiments with reference to drawing figures, wherein:

FIG. 1 illustrates a vertical cross-sectional view of the combustion arrangement according to the invention;

FIG. 2 illustrates a horizontal cross-sectional view of a lower portion of the combustion arrangement according to FIG. 1;

FIG. 3 illustrates a vertical cross-sectional view of another embodiment of the combustion arrangement according to the invention; and

FIG. 4 illustrates a horizontal cross-sectional view of the combustion arrangement according to FIG. 3.

### DETAILED DESCRIPTION OF THE INVENTION

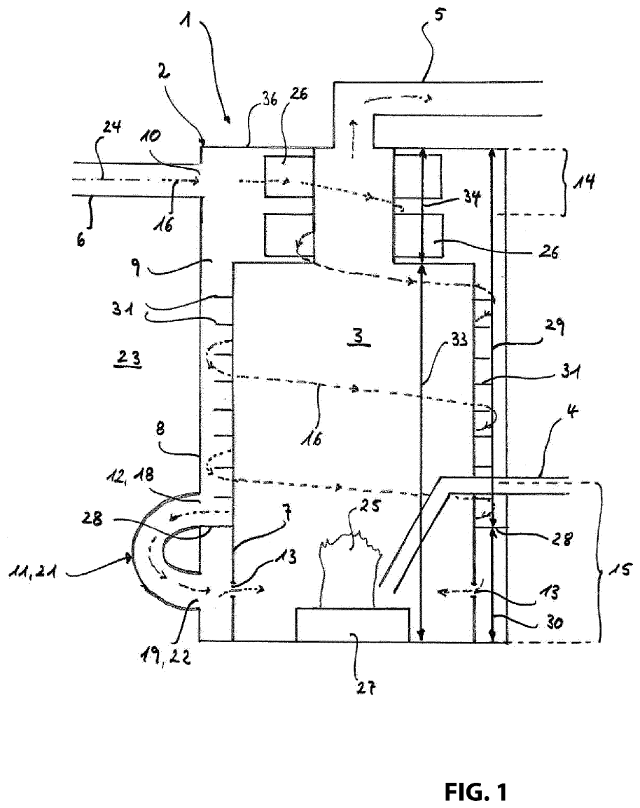

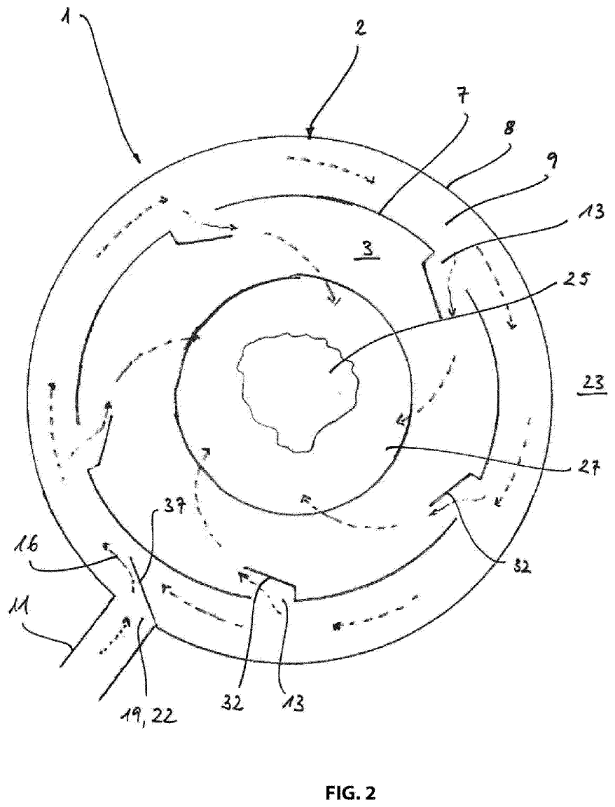

A first embodiment that is shown in FIGS. 1 and 2 includes a combustion arrangement 1 that includes a combustion chamber 3 that is defined by a housing 2 with a circular cross section. The combustion arrangement 1 includes a supply conduit through which a fuel, in particular in a form of pellets is feedable to a combustion table 27 within the combustion chamber 3. A supply conduit 4 is run through the housing 2. The housing 2 is configured double walled and includes an external outer wall 8 and an internal inner wall 7. The outer wall 8 and the inner wall 7 jointly define an intermediate space 9 arranged there between. The combustion arrangement 1 according to the invention further comprises an outlet 5 that is arranged at a ceiling 36 of the housing 2. The outlet 5 is configured to let out exhaust gases, in particular smoke gasses that are generated by the combustion of the respective fuel in the combustion chamber 3.

Typically, a combustion arrangement 1 of this type includes at least one heat exchanger arrangement by which thermal energy released by the combustion is transferrable to a heat transfer medium. The heat transfer medium is typically formed by water wherein the heat exchanger arrangement can be formed e.g. by a water spiral that extends in a helical shape within the combustion chamber 3 wherein the water spiral is flow enveloped by hot exhaust gases of the combustion that occurs in the combustion chamber 3. Thermal energy included in the exhaust gas can be transferred in the water spiral to the heat transfer medium which is thus heated by a large amount. In particular, the heat transfer medium is initially evaporated and the steam superheated e.g.; to a temperature about 500° C. Thus, energy included in the respective fuel is converted into thermal energy and then rendered mechanically useable wherein a turbine is drivable by the steam, typically water steam. Exhaust gas that exits the combustion arrangement 1 is also usable for pre-drying a fuel that is to be combusted.

An air channel 6 is connected to the intermediate space 9, wherein supply air is conductible by the air channel 6 through an air inlet opening 10 into the intermediate space 9. The air inlet opening 10 is arranged in an upper end section 14 of the housing 2, wherein the air inlet opening 10 is advantageously arranged directly below a ceiling 36 of the housing 2. The supply air flows initially into the air channel 6 in a main flow direction 16 that is parallel to a center axis 24 of the air channel 6 before the supply air is deflected into the intermediate space 9 by air control elements 26, 31. The air control elements 26, 31 are arranged in the intermediate space 9 and configured to force the supply air into a spiral flow about the inner wall 7. This is based on the concept that the supply air is heatable by flowing about the inner wall 7 wherein the inner wall 7 has a high temperature due to the combustion in the combustion chamber 3. Thus, the supply air is run from the air inlet opening 10 within the intermediate space 9 downward towards a lower end section 15 of the housing 2 and thus heated.

The air control elements 26, 31 are configured differently in the illustrated embodiment. In particular the air control elements 26 are associated with an upper wide portion 34 of the housing 2 whereas the air control elements 31 are associated with a narrow portion 33. The wide portion 34 and the narrow portion 33 differ in a width of the intermediate space 9 that is measured in the radial direction. The housing 2 is configured in the illustrated embodiment so that a diameter of the outer wall 8 is configured constant over the entire height of the housing 2. The inner wall 7, however, is configured with a variable diameter wherein the inner wall 7 has a small diameter in the wide portion 34 and a large diameter in the narrow portion 33. This has the consequence that radially measured distance between the inner wall 7 and the outer wall 8 that corresponds to a width of the intermediate space 9 which is greater in the wide portion 34 than in the narrow portion 33. The wide portion 34 is typically associated with the upper end section 14 in which the air inlet opening 10 of the air channel 6 is arranged. The wide portion 34 has the advantage that enough space is available in the intermediate space 9 to arrange comparatively large air control elements 26. The air control elements are configured to impart a helical flow pattern upon the supply air wherein the air control elements are arranged with a corresponding orientation at the inner wall 7. Thus, the air control elements 26 are formed by plate shaped components that extend from the inner wall 7 in a direction towards the outer wall 8. The air control elements 26 can be inclined at least partially relative to vertical in order to provide a deflection of the main flow direction 16 of the supply air downward at a slant angle.

As soon as the spiral flow of the supply air is set in motion additional measures to maintain the spiral flow only require smaller air control elements 31. These are arranged in the narrow portion 33 and formed in the illustrated embodiment by elongated air control plates that are adapted to a camber of the inner wall 7. These air control plates can extend essentially horizontally viewed in particular in the circumferential direction of the inner wall 7 or can be configured slightly inclined relative to horizontal in particular inclined by less than 10°, advantageously by less than 5°. Advantageously a portion of the air control elements 31 is arranged horizontal while another portion of the air control elements 31 is inclined relative to horizontal. This way air channels are formed along the inner wall 7 in the narrow portion 33 that maintain the spiral flow of the supply air about the inner wall 7 wherein a slope of the flow is kept small enough so that an air conduction path and thus a dwelling time of the supply air at the inner wall 7 when flowing through the intermediate space 9 is configured as long as possible. This assures that a strong heat transfer occurs from the inner wall to the supply air which heats the supply air by a particularly strong amount. The latter is particularly advantageous for a combustion of highly compressed solid fuels in the combustion chamber 3. The large diameter of the inner wall 7 in the narrow portion 43 makes the circumferential surface of the inner wall 7 particularly large so that the air conduction path along which the supply air flows around the inner wall 7 is particularly long.

The outer wall 8 includes an air exit opening 12 in the lower end section 15 that is arranged below the upper end section 14 wherein the air outlet opening 12 cooperates with the air conduit 11. The air outlet opening 12 is arranged in the narrow portion 33. The air conduit 11 is configured to conduct the supply air from the intermediate space 9 in a radially outward direction out of the housing 2. Put differently, the air conduit 11 extends in an environment 23 of the housing 2. The air conduit 11 is connected with its first end 18 at the air outlet opening 12. A second end 19 of the air conduit 11 cooperates with a pass through opening 22 which is arranged in the outer wall 8 of the housing 2. The air conduit 11 is formed as a 180° arc that is vertically oriented wherein both ends 18, 19 of the arc are arranged at different elevation levels. An outer section 21 of the air conduit 11 extends between the air outlet opening 12 and the pass through opening 22 wherein the outer section forms the entire air conduit 11 in the illustrated embodiment.

In the illustrated embodiment the intermediate space 9 is divided by an intermediate floor 28 into an upper portion 29 and a lower portion 30. The intermediate floor 28 is configured to separate a flow in the upper portion 29 and the lower portion 30 of the intermediate space 9. A flow of the supply air can thus only be provided from the upper portion 29 into the lower portion 30 using the air conduit 11. Thus, the air outlet opening 12 cooperates with the upper portion 29 and the pass through opening 22 cooperates with the lower portion 30 of the intermediate space 9. Accordingly, the air conduit 11 represents the only flow connection between the upper portion 29 and the lower portion 30. The pass through opening 22 feeds the supply air to the lower portion 30 of the intermediate space 29. The supply air is then fed from the lower portion 30 through a plurality of pass through openings 13 that are arranged in the inner wall 7 into the combustion chamber 3. Within the combustion chamber 3 the supply air is eventually conducted into the fire 25 so that the supply air is available as a reaction partner for the combustion reaction of the respective fuel.

As evident from FIG. 2, that shows a horizontal cross-section through the housing 2 in the lower portion 30 the supply air is deflected by an air control element 37 during a transition of the supply air from the air conduit 11 into the intermediate space 9 so that the main flow direction 16 of the supply air is provided with a tangential flow component. This causes the supply air to flow in a circular pattern from the pass through opening 22 within the intermediate space 9 about the inner wall 7. The pass through openings 13, wherein five of them are distributed in the illustrated embodiment in a uniform pattern about the circumference of the inner wall 7, respectively offset from each other by 72 degrees, facilitate a transfer of the supply air into the combustion chamber 3. Thus, the transfer openings 13 are configured as horizontal slots that form a flow resistor for the supply air. This way the transfer openings 13 act as throttles that lead to a local increase of the flow velocity of the supply air when entering the combustion chamber 3. The transfer openings 13 also cooperate with air conducting elements 32 that provide a tangential flow of the supply air into the combustion chamber 3. Due to the oxygen consumption of the fire 25 the supply air is eventually sucked into the fire 25 by a vacuum formed in the fire 25. Thus, a tangential flow component of the supply air is maintained long as possible.

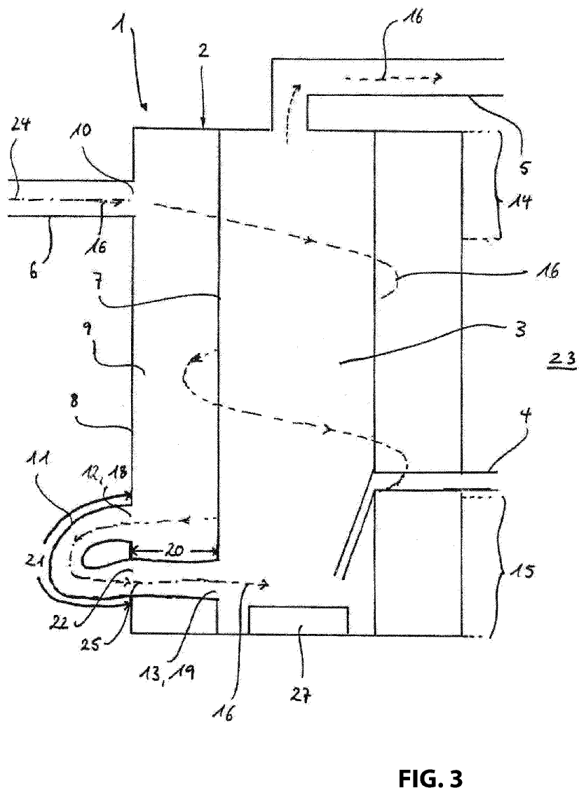

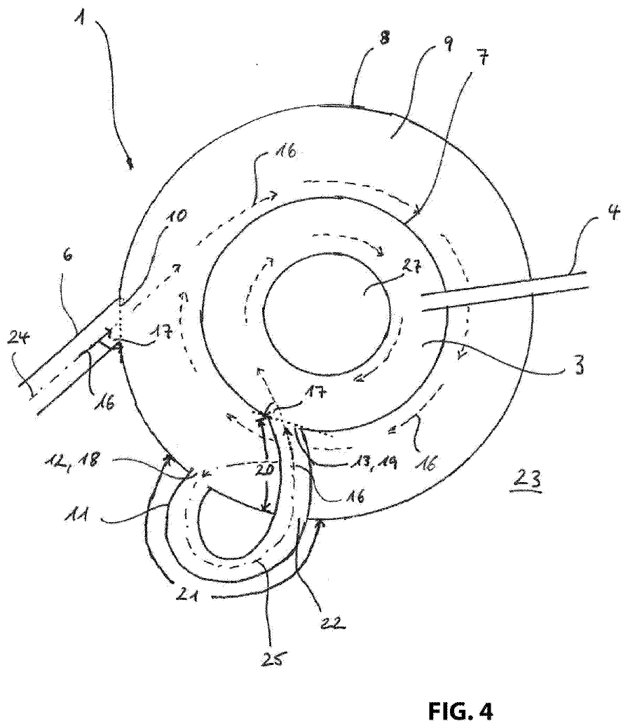

In another advantageous embodiment that is illustrated in FIGS. 3 and 4 the essential difference to the embodiment according to FIGS. 1 and 2 is that supply air is conducted directly from the intermediate space 9 through the air conduit 11 directly into the combustion chamber 3. Thus, the air conduit 11 is run from the air exit opening 12 in the lower end section 15 of the housing 2 away from the housing 2 and then passes through the outer wall 8 in the portion of a pass-through opening 22. Thereafter the air conduit 11 extends from the pass-through opening 22 through the intermediate space 9 and terminates at a transfer cross section 13 where the second end 19 of the air conduit 11 is connected. The air conduit 11 includes an outer section 21 that extends outside of the housing 2 and an inner section 20 that extends within the housing 2, more precisely within the intermediate space 9. This configuration causes the spiral shaped main flow direction 16 of the supply air that prevails in the intermediate space 9 to be interrupted or stopped since the supply air is forced into the air conduit 11 which forces the supply air into a flow within the air conduit 11. The housing 2 is dosed in its upper end section 15 so that supply air can only exit through the air conduit 11 from the intermediate space 9. Since the air conduit 11 is directly connected to the combustion chamber 3 as described supra flowing the supply air from the air conduit 11 into the combustion chamber 3 facilitates controlling the main flow direction 16 of the supply air. In particular it is conceivable to connect the air conduit 11 to the inner wall at a slant angle relative to the inner wall so that the main flow direction 16 of the supply air is oriented at an angle 35 relative to the transmission cross section 13. The angle 35 is approximately 60° so that a tangential flow component is imparted upon the supply air. This causes the supply air to flow around the combustion table 27 in a circular pattern or in a vortex which has proven particularly advantageous for the combustion of highly compressed solid fuels.

Independently from the direct connection of the air conduit 11 at the inner wall 7 the intermediate space 9 is configured with a constant cross section over an entire height of the housing 2 in the second embodiment. Generating a spiral flow in the portion of the intermediate space 9 is achieved at least initially by a slanting of the air channel 6 relative to the outer wall 8. This slanting is done so that the main flow direction 16 of the supply air that is oriented parallel to the center axis 24 of the channel 6 encloses and angle 17 of about 70° with a plane of the air inlet opening 10. This way the supply air is already conductible into the intermediate space 9 with a tangential flow component, wherein the housing 12 develops a downward flow pattern of the supply air due to the arrangement of the air outlet opening 12 in the lower end section 15 of the housing 2. As a result, this yields the spiral shaped flow characteristics of the supply air from the air inlet opening 10 to the air outlet opening 12.

### REFERENCE NUMERALS AND DESIGNATIONS

1 combustion arrangement

2 housing

3 combustion chamber

4 inlet

5 outlet

6 air conduit

7 inner wall

8 outer wall

9 intermediate space

10 air inlet opening

11 air conduit

12 air outlet opening

13 transition opening

14 upper end section

15 lower end section

16 main flow direction

17 angle

18 first end

19 second end

20 inner section

21 outer section

22 pass through opening

23 ambient

24 center axis

25 fire

26 air control element

27 combustion table

28 intermediate floor

29 upper portion

30 lower portion

31 air control element

32 air control element

33 narrow portion

34 wide portion

35 angle

36 ceiling

37 air control element

What is claimed is:

1. A method for operating a combustion arrangement, the combustion arrangement including
at least one combustion chamber arranged in a double-walled housing,
at least one inlet configured to supply a fuel to the at least one combustion chamber,
at least one outlet for letting exhaust air from the at least one combustion chamber, and
at least one air channel configured to feed supply air into the housing,
wherein the housing includes an inner wall and an outer wall which jointly define an intermediate space between each other,
wherein an air inlet opening that cooperates with the at least one air channel is arranged in an upper end section of the outer wall so that the supply air is feedable through the at least one air channel into the intermediate space,
wherein the intermediate space and the at least one combustion chamber that is enveloped by the inner wall are flow connected so that the supply air conducted into the intermediate space is transferable into the at least one combustion chamber,
the method comprising the steps:
introducing the supply air into the upper end section of the housing through the at least one air channel;
guiding the supply air in the intermediate space towards a lower end section of the housing;
introducing the supply air into the at least one combustion chamber; and
initially running the supply air out of the housing through an air conduit that cooperates with an air outlet opening arranged in the outer wall; and
thereafter running the supply air into the at least one combustion chamber at least indirectly.

2. The method according to claim 1,
wherein the intermediate space is divided by an intermediate floor in the lower end section into an upper portion and a lower portion,
wherein the supply air is conducted exclusively by the air conduit from the upper portion into the lower portion of the intermediate space.

3. The method according to claim 2, wherein the supply air is run from the lower portion of the intermediate space through at least one transfer opening into the at least one combustion chamber.

4. The method according to claim 1,
wherein the supply air is deflected by at least one first air control element when transitioning into the combustion chamber, and
wherein a tangential flow component is advantageously imparted upon the supply air by the at least one air control element during the transitioning.

5. The method according to claim 1, wherein the supply air flows from the air inlet opening to the air outlet opening of the outer wall in a downward spiral pattern flow about the inner wall.

6. The method according to claim 5, wherein the supply air is deflected by at least one second air control element within the intermediate space so that the downward spiral pattern flow is generated.

7. The method according to claim 1,
wherein the supply air is introduced into the intermediate space with a tangential direction component viewed in a horizontal sectional plane of the combustion arrangement, and
wherein a main flow direction of the supply air encloses an angle between 60° and 90° with the outer wall at the air inlet opening.

8. A combustion arrangement configured to burn pellets made from renewable material, the combustion arrangement comprising:
at least one combustion chamber arranged in a double-walled housing;
at least one inlet for supplying a fuel to the at least one combustion chamber;
at least one outlet for letting exhaust air out of the at least one combustion chamber; and
at least one an air channel configured to feed supply air into the housing,
wherein the housing includes an inner wall and an outer wail which jointly define an intermediate space between each other,
wherein an air inlet opening that cooperates with the at least one air channel is arranged in an upper end section of the outer wall so that the supply air is feedable through the at least one air channel into the intermediate space,
wherein the intermediate space and the at least one combustion chamber that is enveloped by the inner wall are flow connected so that the supply air conducted into the intermediate space is transferable into the at least one combustion chamber,
wherein a first end of an air conduit cooperates with an air outlet opening that is arranged in the outer wall in a lower end section of the housing,
wherein at least an outer section of the air conduit extends outside of the housing, and
wherein the supply air is conductible from the air outlet opening into the combustion chamber at least indirectly.

9. The combustion arrangement according to claim 8,
wherein the intermediate space is divided by an intermediate floor into an upper portion and a lower portion, and
wherein the supply air is conducted exclusively through the air conduit from the upper portion into the lower portion.

10. The combustion arrangement according to claim 9, wherein the inner wall includes a plurality of transfer openings that provide a flow connection between the lower portion of the intermediate space with the at least one combustion chamber.

11. The combustion arrangement according to claim 8,
wherein the outer wall includes a pass-through opening, and
wherein the supply air is feedable by the air conduit through the pass-through opening into the intermediate space.

12. The combustion arrangement according to claim 8, wherein a center axis of the at least one air channel encloses an angle between 60° and 90° with the outer wall at the air inlet opening.

13. The combustion arrangement according to claim 8, wherein air control elements are arranged in the intermediate space at the inner wall.

14. The combustion arrangement according to claim 13, wherein the air control elements are formed by guide plates.

15. The combustion arrangement according to claim 8,
wherein the intermediate space is divided into a wide portion and a narrow portion, and
wherein a horizontally measured extension of the intermediate space in the wide portion is greater than in the narrow portion.

16. The combustion arrangement according to claim 15, wherein the air inlet opening cooperates with the wide portion and the air outlet opening cooperates with the narrow portion.
